(19) United States
(12) Patent Application Publication
(10) Pub. No.: US 2022/0397203 A1
(43) Pub. Date: Dec. 15, 2022

(54) ACTUATOR FOR HIGH-PRESSURE VALVE

(71) Applicant: FUJIKIN INCORPORATED, Osaka-shi (JP)

(72) Inventors: Keisuke Ishibashi, Osaka-shi (JP); Tadayuki Yakushijin, Osaka-shi (JP); Ryo Tangotani, Osaka-shi (JP); Tadanobu Yoshida, Osaka-shi (JP); Michio Yamaji, Osaka-shi (JP); Shoichi Uruno, Osaka-shi (JP)

(73) Assignee: FUJIKIN INCORPORATED, Osaka-shi (JP)

(21) Appl. No.: 17/778,397

(22) PCT Filed: Nov. 4, 2020
(86) PCT No.: PCT/JP2020/041137

§ 371 Date: May 19, 2022

(30) Foreign Application Priority Data
Nov. 22, 2019 (JP) 2019-211195

(51) Int. Cl. F16K 7/17; F16K 7/12; F16K 31/122

(52) U.S. Cl. CPC F16K 7/17; F16K 7/126; F16K 31/1225

(57) ABSTRACT

Provided is an actuator including a ball-type thrust amplifier therein that controls a valve in which a high-pressure fluid flows, and having less wear between members and a long lifespan. This actuator for a valve includes a thrust amplification mechanism therein, in which the thrust amplification mechanism includes a disk, a ball presser, a stem, and a plurality of balls that are sandwiched by and in contact with an upper surface of the disk, a tapered surface of the ball presser, and a tapered surface of the stem and disposed to move outward as the stem moves downward, the surfaces of the parts constituting the thrust amplification mechanism are coated with grease containing an additive, and the additive of the grease includes at least chloroalkane.

### TECHNICAL FIELD

The present invention relates to an actuator for a high-pressure valve including a thrust amplifier.

### BACKGROUND ART

A metal diaphragm valve or the like used in a semiconductor manufacturing apparatus or the like generally has a metal diaphragm and a resin annular valve seat, and an actuator is mounted on an upper side of the valve. The actuator includes a stem that directly presses a diaphragm pressing body disposed on an upper portion of the diaphragm to move the diaphragm pressing body up and down, and the stem presses or releases the diaphragm through the diaphragm pressing body to open and close a flow path between the diaphragm and a packing.

In manufacture of a semiconductor, it may be required to flow a high-pressure fluid to a valve such as a diaphragm valve, and in such a case, it is required to increase thrust during diaphragm operation performed by the actuator. A structure of a piston and a cylinder is often used in such an actuator of a valve for a high pressure, but the higher the pressure of the flowing fluid is, the larger the thrust force is required, and the larger piston and cylinder are required to be used. Further, it is required to use the structure of the piston and the cylinder in multiple stages. However, when such a structure is used, a size of the actuator increases.

In order to solve such a problem, an invention disclosed in PTL 1 includes a hardball and a tapered pressing member, and the pressing member is used as a wedge to act on the hardball to increase a force for pressing a diaphragm.

An embodiment in FIG. 14 of PTL 1 is shown in FIG. 5. An actuator 101 includes a ball 102, a small-diameter needle 104 having a substantially conical inclined surface 103, a cylindrical member 106 having a mortar-shaped inclined surface 105, and a pressing member 108 that presses a diaphragm presser 107. The actuator 101 is of a so-called normally closed (NC) type in which a diaphragm 112 in a diaphragm valve 111 is maintained in a closed state by an elastic force of a spring 110 provided in a body portion 109 in a normal state. When compressed air flows into the body portion 109 of the actuator 101, a piston portion 113 provided in the body portion 109 rises, and a needle 104 also rises together with the piston portion 113. When the needle 104 rises, the ball 102 moves in a diameter decreasing direction along the inclined surface 103 around the needle, and the ball 102 also moves upward to be guided to the inclined surface 105 of the cylindrical member 106 to release pressing applied by a pressing member 108, and the diaphragm body 112 rises to enter a valve open state. At this time, a stroke (not shown) when the needle 104 moves up and down is about 5 to 6 times a stroke when the pressing member moves up and down.

Conversely, when the needle 104 moves downward and the ball 102 moves outward, the pressing member 108 moves in an upper-lower direction only by a stroke of about ⅕ to ⅙ of the stroke of the needle 104, and a large pressure (a pressure applied by thrust of 5 to 6 times thrust applied by the piston) is applied to the inclined surface 103 that is in contact with the ball 102, an upper surface of the pressing member 108, the inclined surface 105, and a surface of the ball 102.

### CITATION LIST

### Patent Literature

PTL 1: JP-B-H08-6828

### SUMMARY OF INVENTION

### Technical Problem

When a ball-type thrust amplifier disclosed in PTL 1 is used, since the thrust is amplified, it is convenient to control the valve for a high pressure, but since wear of a contact portion with the ball is likely to occur and a load is applied to various members, a decrease in amplification factor due to wear deterioration and a decrease in closing performance of the valve at an early stage are likely to occur.

An object of the invention is to provide an actuator including a ball-type thrust amplifier therein that controls a valve in which a high-pressure fluid flows, and having less wear between members constituting the ball-type thrust amplifier and a long lifespan, as compared with the actuator of the related art.

### Solution to Problem

The invention (1) is an actuator for a valve including a thrust amplification mechanism therein that increases thrust for pressing a valve body to open and close a flow path, in which the thrust amplification mechanism includes a disk provided between an output end of the actuator and the valve body and configured to transmit the thrust for pressing the valve body, a ball presser disposed above the disk and having a conical tapered surface spreading outward and downward, a stem configured to pass through a through hole formed in a central portion of the ball presser and having a tapered surface whose tip end on a valve body side is tapered, and a plurality of balls sandwiched by and in contact with an upper surface of the disk, a tapered surface of the ball presser, and a tapered surface of the stem and disposed to move outward as the stem moves downward, a movement space of the balls is filled with grease containing an additive, and the additive includes at least chloroalkane in a group of sulfurized spam oil, sulfurized aliphatic ester, dibenzyl disulfide, alkyl polysulfide, olefin polysulfide, xanthic sulfide, chlorinated paraffin, methyltrichlorostearate, the chloroalkane, lead naphthenate, alkylthiophosphate amine, and chloroalkylxanthate.

As a feature of the actuator for a valve according to the invention (1), the disk and the ball presser are coated with an alloy coating film, the upper surface of the disk, the tapered surface of the ball presser, the tapered surface of the stem, and surfaces of the balls are coated with the grease containing an additive, and the additive includes at least chloroalkane in a group of sulfurized spam oil, sulfurized aliphatic ester, dibenzyl disulfide, alkyl polysulfide, olefin polysulfide, xanthic sulfide, chlorinated paraffin, methyltrichlorostearate, the chloroalkane, lead naphthenate, alkylthiophosphate amine, and chloroalkylxanthate.

By coating a sliding portion with the grease containing such additives, wear of the sliding portion is reduced, and the actuator for a valve having a long lifespan can be provided. A feature of the grease is that the grease includes the chloroalkane as an essential component. Although a single component of the chloroalkane may be contained as the additive, an effect as lubricating grease can be expected by using the chloroalkane in combination with additives of other components.

The lubricating grease basically includes a base oil, a thickener, and additives. Examples of the base oil mainly include mineral oils, and include synthetic lubricating oils such as ester oils, ether oils, polyalkylene glycols, silicone oils, synthetic hydrocarbon oils, and fluorine-based oils. As the thickener, metal soaps such as lithium soaps, calcium soaps, and aluminum soaps of higher fatty acids are generally used. As the additives, similarly to a general lubricating oil, an antioxidant is added as necessary for preventing oxidative degradation of the grease, and an extreme-pressure agent such as a sulfur-based compound or a phosphorus-based compound, an oiliness agent (friction reducing agent) such as a higher fatty acid or oil and fat, a solid lubricant such as molybdenum disulfide or graphite, a rust preventive agent, and the like are added as necessary for improving lubricity.

The grease is a dispersion system having a structure in which a tissue of the thickener that is a solid in a base oil of Newtonian fluid is formed to provide a non-Newtonian property. The flow property of the grease is uncertain rather than complex, and in addition to being softened (rarely cured) due to shearing, the flow property also changes due to temporal duration of shearing and recovers due to pause. In rolling contact, there are two extreme situations of full lubrication and depletion lubrication, that is, best and worst situations. The actuator for a high-pressure valve including the thrust amplification mechanism therein is presumed as an actuator that a depletion state in which the lubricating grease is less likely to enter a contact portion of members is likely to occur.

In the case of the depletion lubrication, only a limited amount of the lubricant contributes to the lubrication, and an oil film becomes considerably thinner than a level of the full lubrication. Since the grease is pushed away from a raceway surface when a rolling body such as a ball passes through, depletion easily occurs at an inlet portion in grease lubrication. Due to rheology properties (plasticity and shear rate dependency) of the grease, the pushed grease cannot easily return to the raceway surface. A small amount of grease remaining on a starting surface is used up every time the grease is exposed to rotational contact, and when the grease is not resupplied to the starting surface, a film thickness continues to decrease, and finally, the members directly rub each other to cause damage.

On a contact surface with a high load, temperature is always high, and the high temperature becomes a trigger for reacting the additive. As the additive, an additive that is stable at room temperature or a relatively low temperature, is activated at a temperature slightly lower than a high temperature at which fusion occurs and reacts with a metal, and has a high reaction rate is suitable. In the grease used for the high-pressure valve of the related art, under severe conditions of high pressure and high temperature, the grease components are depleted, and metal surfaces are brought into direct contact with each other to cause abnormal wear, so that thrust of the thrust amplification mechanism is reduced, and thereby making it impossible to control the valve.

When the grease containing at least the chloroalkane as the additive is coated on a rubbed portion of the thrust amplification mechanism, even under the severe conditions of high pressure and high temperature, the chloroalkane component slightly remains on the metal surfaces, the metal surfaces do not rub against each other, and the abnormal wear does not occur. Although this mechanism is not necessarily clear, it is presumed that the chloroalkane component does not react with metal atoms on the surfaces and the chloroalkane component as the lubricant is not completely depleted in an appropriate temperature range of a high temperature.

The invention (2) is the actuator for a valve according to the invention (1), in which the ball presser includes a contact member in contact with the balls, and a lid member configured to detachably press and fix the contact member from above. By forming such a structure, the entire ball presser may not be replaced and only the contact member is replaced even if a contact surface of the ball presser is worn, and thus a cost can be reduced.

The invention (3) is the actuator for a valve according to the invention (1) or (2), in which the actuator is of a type that generates the thrust by a piston driven by air, and an upper end of the stem is detachably engaged with a lower portion of the piston. By forming such a structure, the piston is not required to be replaced even if a contact surface of a tip end portion of the stem is worn, and thus the cost can be reduced.

### Advantageous Effect

By forming the actuator for a valve having the structure as in the invention, an actuator having less wear between members constituting the ball-type thrust amplifier and long lifespan as compared with the actuator of the related art can be provided.

### BRIEF DESCRIPTION OF DRAWINGS

FIG. 1 shows an actuator for a valve according to Embodiment 1 of the invention, which is attached to a valve.

FIG. 2 shows the actuator for a valve according to Embodiment 1 when the valve is in a closed state.

FIG. 3 shows the actuator for a valve according to Embodiment 1 when the valve is in an open state.

FIG. 4 shows a test result of a forward pressurization durability test.

FIG. 5 shows an actuator for a valve of the related art, which is attached to a valve.

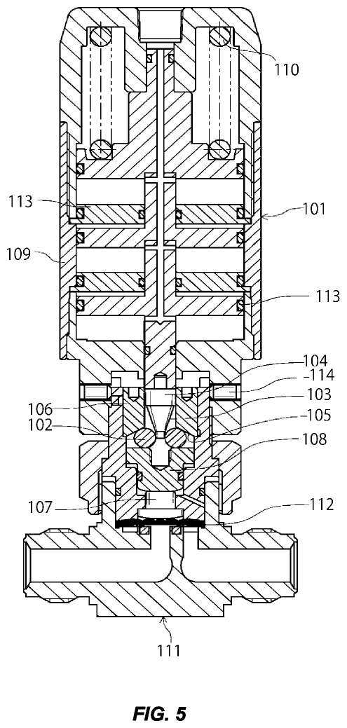

### DESCRIPTION OF EMBODIMENTS

Hereinafter, a preferred embodiment of the invention will be described in detail with reference to the drawings. Shapes, relative arrangements, and the like of components described in the embodiment are not intended to limit the scope of the invention unless particularly specified, and are merely illustrative examples. In addition, directions of members and the like may be referred to as, for convenience, up, down, left, and right depending on directions in the drawings, but these directions do not limit the scope of the invention.

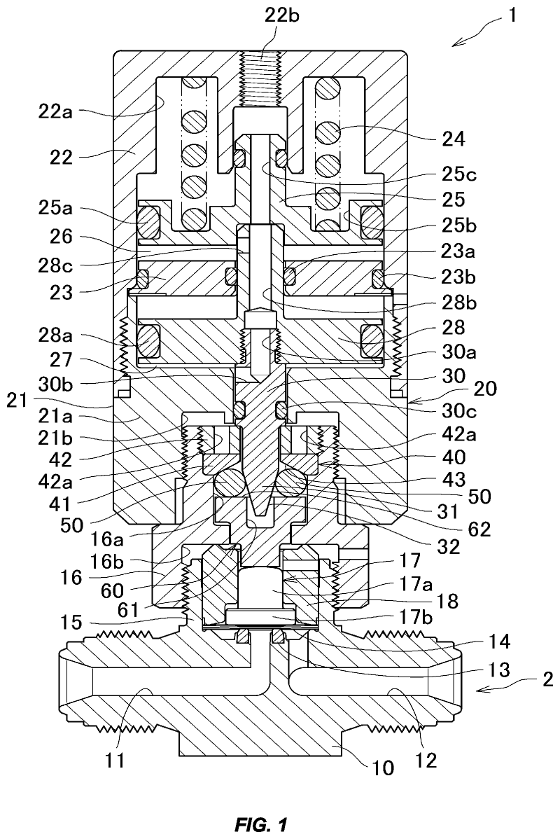

FIG. 1 shows an actuator 1 for a valve, which is attached to a valve 2. A fluid inflow passage 11, a fluid outflow passage 12, and an annular valve seat 13 are formed in a body 10 of the valve 2. An upward protruding portion 15 is formed above the body 10, a recess portion is formed in the upward protruding portion 15, a diaphragm (valve body) 14 in contact with the annular valve seat 13 is disposed, and a diaphragm fixing member 18 fixing a peripheral edge of the diaphragm 14 is disposed. A through hole is formed in the center of the diaphragm fixing member in an upper-lower direction, a diaphragm presser 17 inserted through the through hole is disposed, and the diaphragm presser 17 includes a shaft portion 17a and a contact portion 17b. A screw thread is formed in an outer periphery of the upward protruding portion 15, and a bonnet 16 screwed with the screw thread is disposed, and a bonnet upper recess portion 16a and a bonnet lower recess portion 16b are formed.

A casing 20 includes an upper casing 22 and a lower casing 21, which are screwed with each other by the screw thread. A first piston 25 is disposed in an upper casing recess portion 22a inside the upper casing 22, a first piston recess portion 25b is provided in an upper portion of the first piston 25, and a compression coil spring 24 biasing the first piston 25 from above to below is disposed between a bottom surface of the recess portion and a ceiling lower surface of the upper casing recess portion 22a.

A counter plate 23 is disposed below the first piston 25, and an upper operation air introducing chamber 26 is formed between the first piston 25 and the counter plate 23. A second piston 28 is disposed inside the lower casing 21 below the counter plate 23.

An operation air inlet 22b for driving the pistons is provided in an upper portion of the upper casing 22, and there are a route in which operation air passes through a first piston axial air passage 25c formed in the first piston 25, passes through a second piston radial air passage 28c, and enters the upper operation air introducing chamber 26, and a route in which the operation air passes through a second piston axial air passage 28b formed in the second piston 28, passes through a stem axial air passage 30a and a stem radial air passage 30b that are formed in the stem 30 connected to a lower portion of the second piston 28, and enters a lower operation air introducing chamber 27 formed below the second piston 28. In order to maintain airtightness, portions between the casings and the pistons and the like are sealed by O-rings 25a, 23a, 23b, 28a, and the like. A bottom wall 21a is formed at a lower portion of the lower casing 21, and a thrust amplification mechanism accommodating recess portion 21b accommodating a thrust amplification mechanism is formed in the bottom wall 21a.

A through hole penetrating in an upper-lower direction is formed in the center of the bottom wall 21a, and the stem 30 penetrates through the through hole. A portion between the stem 30 and the bottom wall 21a is sealed by the O-rings 30c to maintain airtightness.

A disk 60 is disposed on a bottom of the bonnet upper recess portion 16a, a disk recess portion 61 is formed in the center, and a stem tip end portion 31 at a tip end of the stem 30 penetrates along with downward movement of the stem 30. Balls 50 are disposed on an upper surface 62 of the disk 60. When the number of balls to be disposed is three, the balls are disposed at intervals of 120 degrees, and when the number of balls to be disposed is four, the balls are disposed at intervals of 90 degrees. Since a size of the actuator becomes large when the number of balls is too large, the number of balls is preferably three to four when a compact actuator is formed.

Ball pressers 40 each having a ball pressing tapered surface 43, which is a conical tapered surface expanding outward and downward, are disposed above the balls 50. Each of the ball pressers 40 includes a contact member 41 having a ball pressing tapered surface 43 and a lid member 42 having a through hole 42a. A male screw thread is formed in an outer periphery of the lid member 42 and screwed into a female screw thread formed in an inner wall of the thrust amplification mechanism accommodating recess portion. A tip end of a special tool is inserted into the through hole 42a, and the ball presser 40 is pressed from above by turning the lid member 42. The stem tip end portion 31 at the tip end of the stem 30 has a tapered surface 32. The tapered surface 32, the ball pressing tapered surface 43, and the upper surface 62 are in contact with surfaces of the balls 50.

Since the stem tip end portion 31, the contact member 41, the disk 60, and the balls 50 that constitute the thrust force amplification mechanism are subjected to friction wear, a material that is hard to wear is preferably used. In order to make it difficult to wear, a coating that cures the surfaces is applied. In particular, members requiring coating are the disk 60 and the contact member 41. The contact member 41 is separate from the lid member 42a in which the male screw thread is formed, and it is unnecessary to perform screw thread processing after coating processing is performed. In the following embodiment and comparative examples, the same coating is performed on the surfaces of these members in common.

The coating includes a base layer on the surface of each member and a coating layer coated on the base layer, the base layer is formed by co-depositing nickel and fluorine-based polymer compound fine particles that are subjected to electroless plating processing on the surface of the member by using a plating solution obtained by dispersing the fluorine-based polymer compound fine particles in a nickel plating solution with a surfactant, and the coating layer includes a first gold-based plating layer that is formed by performing gold plating processing on the base layer and a second gold-based plating layer that is formed by performing the electroless plating processing on a surface of the first gold-based plating layer by using a plating solution obtained by dispersing the fluorine-based polymer compound fine particles in a gold plating solution with a surfactant, and by co-depositing gold and the fluorine-based polymer compound fine particles. Here, PTFE was used as a fluorine-based polymer compound. In this way, hardness is increased, and a slip property is increased by blending the fluorine-based polymer compound.

In addition, the coating processing can be alloy coating processing. As an example of synthetic coating processing, a binary synthetic coating using cobalt and phosphorus exerts a large effect on prevention of galling between metals, in particular, between stainless steels. Further, coating processing using nickel and phosphorus, or using nickel, phosphorus, and tungsten can also be performed.

Further, a movement space of the balls 50 is filled with grease containing an additive, and the additive includes at least chloroalkane in a group of sulfurized spam oil, sulfurized aliphatic ester, dibenzyl disulfide, alkyl polysulfide, olefin polysulfide, xanthic sulfide, chlorinated paraffin, methyl trichloro stearate, chloroalkane, lead naphthenate, alkylthiophosphate amine, and chloroalkylxanthate.

The chloroalkane is not particularly limited as long as the chloroalkane is chlorinated paraffin, but in the present embodiment, medium-chain chlorinated paraffin having 14 to 17 carbon atoms (chloroalkane (C14 to C17)) is preferably used.

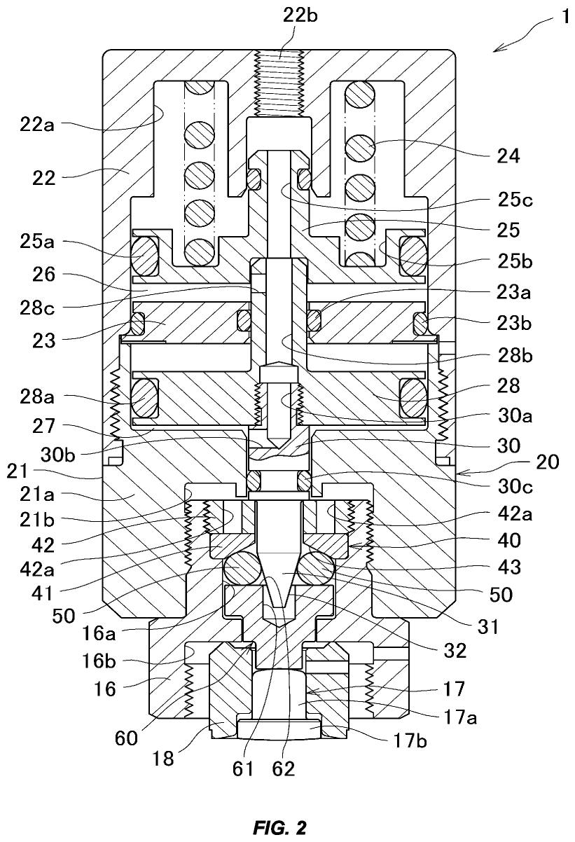

FIG. 2 shows the actuator 1 according to Embodiment 1 when the valve 2 is in a closed state. The second piston 28 is lowered to a lower end, and the stem tip end portion of the stem 30 is lowered to the lower end, thereby moving the balls 50 outward. When the balls 50 move outward, a downward force is applied to the upper surface 62, the disk 60 moves downward, the diaphragm presser 17 moves downward, the diaphragm 14 comes into close contact with the annular valve seat 13, and the valve 2 is in the closed state. By the mechanism, thrust generated by the pistons is amplified.

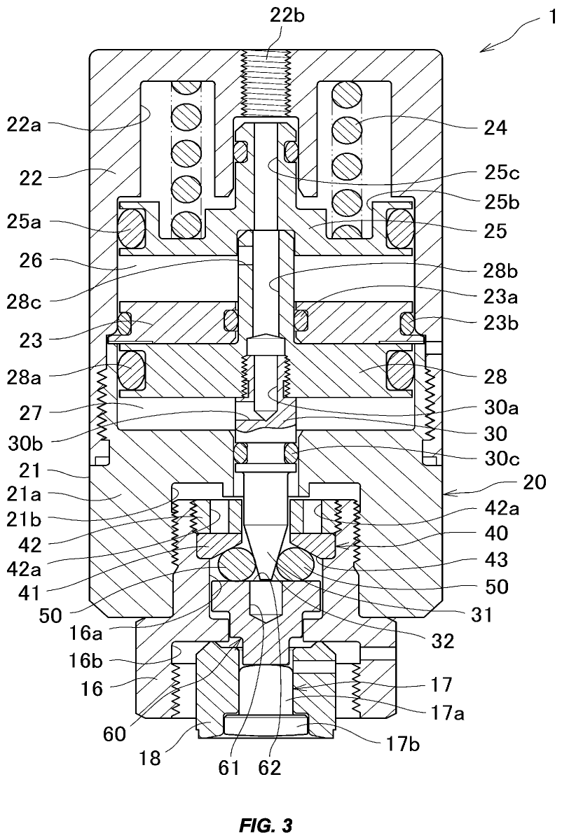

FIG. 3 shows the actuator 1 according to Embodiment 1 when the valve 2 is in an open state. Air is introduced into the upper operation air introducing chamber 26 and the lower operation air introducing chamber 27, the first piston 25 and the second piston 28 move upward, and accordingly, the stem 30 moves upward and the balls 50 move inwardly. The disk 60 also moves upward, the diaphragm presser 17 also moves upward, and the valve 2 is in the open state.

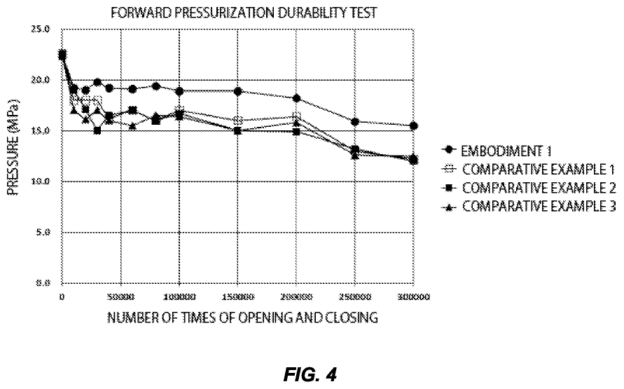

FIG. 4 is a diagram showing a result of the forward pressurization durability test of a valve seat close performance test. Here, in the forward pressurization durability test, a measurement is performed as follows. In the valve open state, an outlet of the fluid outflow passage 12 is closed, a pressure of the fluid (for example, nitrogen gas) flowing through the valve is increased to 23 MPa, an inlet of the fluid inflow passage 11 is closed, and the valve 2 is closed in this state. Thereafter, the outlet of the fluid outflow passage 12 is opened. At this time, if a close capability is high, a pressure on an inlet side of the fluid inflow passage 11 does not decrease, but actually slightly decreases and stops. Values of the pressure are shown in the diagram of the forward pressurization durability test of FIG. 4.

Mechanical structures of the actuators of the embodiment and the comparative examples in FIG. 4 are exactly the same, and only the grease is different. All the greases used in the embodiment and the comparative examples contain 79% to 81% by weight of the synthetic oil as the base oil, 5% to 6% by weight of the thickener, and 9% to 11% by weight of the additive, whereas the greases used in the comparative examples do not contain the chloroalkane. The grease used in the embodiment contains the chloroalkane.

In view of the result of the forward pressurization durability test in FIG. 4, in the comparative examples 1 to 3, the pressure decreases to near 15 MPa when the number of times of opening and closing is 50,000, and the pressure decreases to less than 15 MPa when the number of times of opening and closing exceeds 200,000. In contrast, in Embodiment 1, the pressure can be maintained at 15 MPa or higher even if the number of times of opening and closing exceeds 300,000.

### INDUSTRIAL APPLICABILITY

According to the actuator for a valve according to the invention, wear between members constituting the thrust amplification mechanism can be reduced, and thus an actuator for a valve having a long lifespan can be provided.

### REFERENCE SIGN LIST

1 actuator
2 valve
10 body
11 fluid inflow passage
12 fluid outflow passage
13 annular valve seat
14 diaphragm (valve body)
15 upward protruding portion
16 bonnet
16a bonnet upper recess portion
16b bonnet lower recess portion
17 diaphragm presser
17a shaft portion
17b contact portion
18 diaphragm fixing member
20 casing
21 lower casing
21a bottom wall
21b thrust amplification mechanism accommodating recess portion
22 upper casing
22a upper casing recess portion
22b operation air inlet
23 counter plate
23a O-ring
23b O-ring
24 compression coil spring
25 first piston
25a O-ring
25b first piston recess portion
25c first piston axial air passage
26 upper operation air introducing chamber
27 lower operation air introducing chamber
28 second piston
28a O-ring
28b second piston axial air passage
28c second piston radial air passage
30 stem
30a stem axial air passage
30b stem radial air passage
30c O-ring
31 stem tip end portion
32 tapered surface
40 ball presser
41 contact member
42 lid member
42a through hole
43 ball pressing tapered surface
50 ball
60 disk
61 disk recess portion
62 upper surface

1. An actuator for a valve comprising:
a thrust amplification mechanism therein that increases thrust for pressing a valve body to open and close a flow path, wherein
the thrust amplification mechanism includes a disk provided between an output end of the actuator and the valve body and configured to transmit the thrust for pressing the valve body, a ball presser disposed above the disk and having a conical tapered surface spreading outward and downward, a stem configured to pass through a through hole formed in a central portion of the ball presser and having a tapered surface whose tip end on the valve body side is tapered, and a plurality of balls sandwiched by and in contact with an upper surface of the disk, a tapered surface of the ball presser, and a tapered surface of the stem and disposed to move outward as the stem moves downward,
a movement space of the balls is filled with grease containing an additive, and
the additive includes at least chloroalkane in a group of sulfurized spam oil, sulfurized aliphatic ester, dibenzyl disulfide, alkyl polysulfide, olefin polysulfide, xanthic sulfide, chlorinated paraffin, methyl trichloro stearate, the chloroalkane, lead naphthenate, alkylthiophosphate amine, and chloroalkylxanthate.

2. The actuator for a valve according to claim 1, wherein
the ball presser includes a contact member contacting with the balls, and a lid member configured to detachably press and fix the contact member from above.

3. The actuator for a valve according to claim 1, wherein
the actuator is of a type that generates thrust by a piston driven by air, and an upper end of the stem is detachably engaged with a lower portion of the piston.

4. The actuator for a valve according to claim 2, wherein
the actuator is of a type that generates thrust by a piston driven by air, and an upper end of the stem is detachably engaged with a lower portion of the piston.
